(19) United States
(12) Patent Application Publication
(10) Pub. No.: US 2026/0040421 A1
(43) Pub. Date: Feb. 5, 2026

(54) LIGHTING SYSTEM WITH LUMEN DRIFT COMPENSATION

(71) Applicant: ERP POWER, LLC, Westlake Village, CA (US)

(72) Inventors: Michael Archer, Moorpark, CA (US); James H. Mohan, Valencia, CA (US); Louis Chen, Simi Valley, CA (US); Steven C. Krattiger, Northridge, CA (US)

(21) Appl. No.: 19/287,806

(22) Filed: Jul. 31, 2025

Related U.S. Application Data
(60) Provisional application No. 63/677,852, filed on Jul. 31, 2024.
(60) Provisional application No. 63/677,838, filed on Jul. 31, 2024.

(51) Int. Cl. H05B 47/165; H05B 45/18; H05B 45/58

(52) U.S. Cl. CPC H05B 47/165; H05B 45/18; H05B 45/58

(57) ABSTRACT

A lighting system includes a power supply circuit configured to generate a drive signal for powering a light source based on an input power signal; a temperature sensor configured to measure a light source temperature corresponding to the light source; a current control circuit coupled to the light source and configured to adjust a current of the light source based on the drive signal and an adjusted reference signal; and a channel controller configured generate a reference signal based on a dimmer setting, and to adjust the reference signal based on the light source temperature to generate the adjusted reference signal.

### CROSS-REFERENCE TO RELATED APPLICATION(S)

This application claims priority to, and the benefit of, U.S. Provisional Application No. 63/677,838 (“LIGHTING SYSTEM WITH CCT DRIFT COMPENSATION”), filed on Jul. 31, 2024, and U.S. Provisional Application No. 63/677,852 (“LIGHTING SYSTEM WITH LUMEN DRIFT COMPENSATION”), filed on Jul. 31, 2024, the entire contents of which are incorporated herein by reference.

### FIELD

Aspects of the present invention are related to light drivers.

### BACKGROUND

In recent years, light emitting diodes (LEDs) have become a prevalent choice in various lighting applications due to their energy efficiency and versatility. However, LEDs face performance challenges, particularly related to lumen drift, which is the gradual decrease in light output over time.

A primary factor contributing to lumen drift in LEDs is temperature variation. During operation, LEDs generate heat, which leads to a rise in the temperature of the LED junction—the point where electrical energy is converted into light. As the junction temperature increases, the efficiency of light conversion can decrease, resulting in reduced lumen output. Elevated junction temperatures can cause a decrease in the amount of light emitted by the LED, a phenomenon known as lumen depreciation. This reduction in light output diminishes the overall effectiveness of the lighting solution, as the intensity of illumination provided by the LED decreases over time.

Addressing the issue of lumen drift due to temperature rise is crucial for maintaining consistent and reliable lighting performance. While advancements in heat dissipation and thermal management have been made, there remains a need for more effective solutions to mitigate lumen drift and ensure stable LED performance across varying operating temperatures.

The above information disclosed in this Background section is only for enhancement of understanding of the invention, and therefore it may contain information that does not form the prior art that is already known to a person of ordinary skill in the art.

### SUMMARY

Aspects of embodiments of the present invention are directed to a lighting system capable of managing and compensating lumen drift of a light source to enable accurate and consistent light output during operation of the lighting system. In some embodiments, the lighting system has an integrated light source (e.g., an integrated light array, such as an LED array), an integrated power supply, and a wireless module (e.g., to enable wireless dimming) contained within a single, compact, multilayer housing. Thus, the lighting system may receive an AC signal from the wall through two wires and may produce the desired light temperature and intensity, while maintaining all components necessary to convert the AC signal to the desired light output in a single self-contained fixture package.

In some embodiments, the lighting system monitors the temperature of the light source to determine its lumen drift, and adjusts the driving current of the light source accordingly to compensate for the drift and to ensure a consistent light output intensity.

According to some embodiments of the present disclosure, there is provided a lighting system including: a power supply circuit configured to generate a drive signal for powering a light source based on an input power signal; a temperature sensor configured to measure a light source temperature corresponding to the light source; a current control circuit coupled to the light source and configured to adjust a current of the light source based on the drive signal and an adjusted reference signal; and a channel controller configured generate a reference signal based on a dimmer setting, and to adjust the reference signal based on the light source temperature to generate the adjusted reference signal.

In some embodiments, the temperature sensor is a thermistor within a housing of the light source and adjacent to the light source.

In some embodiments, the channel controller is configured to receive the dimmer setting from a dimming controller.

In some embodiments, the channel controller is configured to adjust the reference signal based on a first look-up table (LUT) associating light source temperatures with reference signal deltas for addition to the reference signal to offset a lumen drift in an output light of the light source at corresponding light source temperatures.

In some embodiments, the channel controller is configured to adjust the reference signal based on an equation associating light source temperatures with reference signal deltas for addition to the reference signal to offset a lumen drift in an output light of the light source at corresponding light source temperatures.

In some embodiments, the channel controller is further configured to determine an age of the light source based on a cumulative operating time of the light source and temperatures and light output intensities of the light source over the cumulative operating time of the light source, and to generate the adjusted reference signal further based on the age of the light source.

In some embodiments, the channel controller is configured to generate the adjusted reference signal further based on a second look-up table (LUT) associating ages of the light source with reference signal deltas for addition to the reference signal to offset a lumen drift in an output light of the light source at corresponding ages of the light source, and each of the ages of the light source based on a cumulative operating time of the light source and temperatures and light output intensities of the light source over the cumulative operating time of the light source.

In some embodiments, the channel controller is configured to generate the adjusted reference signal based on a multi-dimensional look-up table (LUT) mapping the light source temperature, a cumulative operating time of the light source, and an average temperature and an average light output intensity of the light source over the cumulative operating time of the light source to a reference signal delta for addition to the reference signal.

In some embodiments, the channel controller is configured to: determine an age of the light source; determine an age-based lumen value corresponding to the light source based on the age and an age compensation table that maps the age to the age-based lumen value; determine a scalar value based on the light source temperature and a temperature compensation table that maps the light source temperature to the scalar value for scaling the age-based lumen value; determine an estimated lumen value of the light source by multiplying the age-based lumen value by the scalar value; determine a reference signal delta based on the estimated lumen value and a third lookup table that maps the estimated lumen value of the light source to the reference signal delta for addition to the reference signal; and calculating the adjusted reference signal based on the reference signal and the reference signal delta.

In some embodiments, the power supply circuit includes: a voltage regulator; and a transformer having a primary winding coupled to the voltage regulator and a secondary winding electrically isolated from the primary winding and coupled to the current control circuit.

In some embodiments, the lighting system further includes: a rectifier circuit configured to rectify the input power signal to generate a rectified signal having a single polarity, wherein the power supply circuit is configured to generate the drive signal based on the rectified signal, and wherein the rectifier circuit is a bridge rectifier and the input power signal is an alternating-current (AC) signal.

In some embodiments, the light source is one of a plurality of light sources including a first light source, a second light source, and a third light source, the first light source includes one or more green light emitting diodes (LEDs), the second light source includes one or more blue LEDs, and the third light source includes one or more red LEDs.

According to some embodiments of the present disclosure, there is provided a method of compensating a lumen drift in an output light of a light source of a lighting system, the method including: receiving, by a channel controller of the lighting system, a light source temperature corresponding to the light source from a temperature sensor; generating, by the channel controller, a reference signal based on a dimmer setting; and adjusting, by the channel controller, the reference signal based on the light source temperature to generate an adjusted reference signal for transmission to a current control circuit of the lighting system, the current control circuit being coupled to the light source and configured to adjust a current of the light source based on a drive signal and the adjusted reference signal.

In some embodiments, the method further includes: receiving, by the channel controller, the dimmer setting from a dimming controller.

In some embodiments, the light system further includes: a power supply circuit configured to generate the drive signal for powering the light source based on an input power signal.

In some embodiments, the adjusting the reference signal is based on a first look-up table (LUT) associating light source temperatures with reference signal deltas for addition to the reference signal to offset the lumen drift in the output light of the light source at corresponding light source temperatures.

In some embodiments, the adjusting the reference signal is further based on a second look-up table (LUT) associating ages of the light source with reference signal deltas for addition to the reference signal to offset the lumen drift in the output light of the light source, and each of the ages of the light source based on a cumulative operating time of the light source and temperatures and light output intensities of the light source over the cumulative operating time of the light source.

In some embodiments, the method further includes: determining, by the channel controller, an age of the light source based on a cumulative operating time of the light source and temperatures and light output intensities of the light source over the cumulative operating time of the light source, wherein the adjusting the reference signal is further based on is further based on the age of the light source.

In some embodiments, the adjusting the reference signal includes: determining an age of the light source; determining an age-based lumen value corresponding to the light source based on the age and an age compensation table that maps the age to the age-based lumen value; determining a scalar value based on the light source temperature and a temperature compensation table that maps the light source temperature to the scalar value for scaling the age-based lumen value; determining an estimated lumen value of the light source by multiplying the age-based lumen value by the scalar value; and determining a reference signal delta based on the estimated lumen value and a third lookup table that maps the estimated lumen value of the light source to the reference signal delta for addition to the reference signal; and calculating the adjusted reference signal based on the reference signal and the reference signal delta.

### BRIEF DESCRIPTION OF THE DRAWINGS

The accompanying drawings, together with the specification, illustrate example embodiments of the present disclosure, and, together with the description, serve to explain the principles of the present disclosure.

FIG. 1 illustrates a lighting system including a CCT drift compensation mechanism, according to some example embodiments of the present disclosure.

FIG. 2 illustrates a schematic diagram of a lighting system including a current control circuit that utilizes a VCR, according to some embodiments of the present disclosure.

FIG. 3A illustrates a perspective view of a lighting system, according to some embodiments of the present disclosure.

FIG. 3B illustrates an exploded perspective view of the lighting system, according to some embodiments of the present disclosure.

FIG. 3C illustrates a cutaway perspective view of the lighting system, according to some embodiments of the present disclosure.

FIG. 3D illustrates a cross-sectional view of the lighting system, according to some embodiments of the present disclosure.

FIGS. 3E and 3F illustrate an exploded perspective view of the layers of the lighting system on which the internal electrical components are mounted to, according to some embodiments of the present disclosure.

FIG. 3G illustrates a partial side view of the layers of the lighting system, according to some embodiments of the present disclosure.

FIG. 4 is a flow diagram illustrating a process of compensating a CCT drift in an output light of a light source of a lighting system, according to some embodiments of the present disclosure.

FIG. 5A illustrates a lighting system including a multi-channel light driver and a lumen drift compensation mechanism, according to some example embodiments of the present disclosure.

FIG. 5B illustrates a schematic diagram of a current control circuit of the multi-channel light driver, according to some embodiments of the present disclosure.

FIG. 6 illustrates a schematic diagram of a current control circuit utilizing a VCR, according to some embodiments of the present disclosure.

FIG. 7 is a flow diagram illustrating a process of compensating a lumen drift in an output light of a light source of a lighting system, according to some embodiments of the present disclosure.

### DETAILED DESCRIPTION

The detailed description set forth below is intended as a description of example embodiments of a compact, integrated multi-layered lighting system, provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

In general, COB lights come in a number of variants including fixed color types, which offer no control over color output, and dual-channel types that provide a range of correlated color temperatures (CCTs). In the latter case, the range is often constrained, limiting the ability to precisely control the produced color. As temperature increases, the color output can shift noticeably. For instance, in many applications where cost-effective high-power output is prioritized (using inexpensive COBs that are pushed to their maximum limits), significant CCT shifts may occur, which could be perceivable to users.

According to some embodiments, the light driver monitors the temperature change of the COB light, which is indicative of CCT drift, and mixes light from an auxiliary light to produce a light output that is compensated for the CCT drift of the COB light. In some embodiments, the light driver has stored therein one or more look-up tables (LUTs) that translate at least the COB temperature to a compensation drive current that drives the auxiliary light. The light driver utilizes the LUT(s) to drive the compensation line based at least on the sensed temperature. In some embodiments, the auxiliary light is injected through a reflector to be mixed with the light produced by the COB light via the reflector.

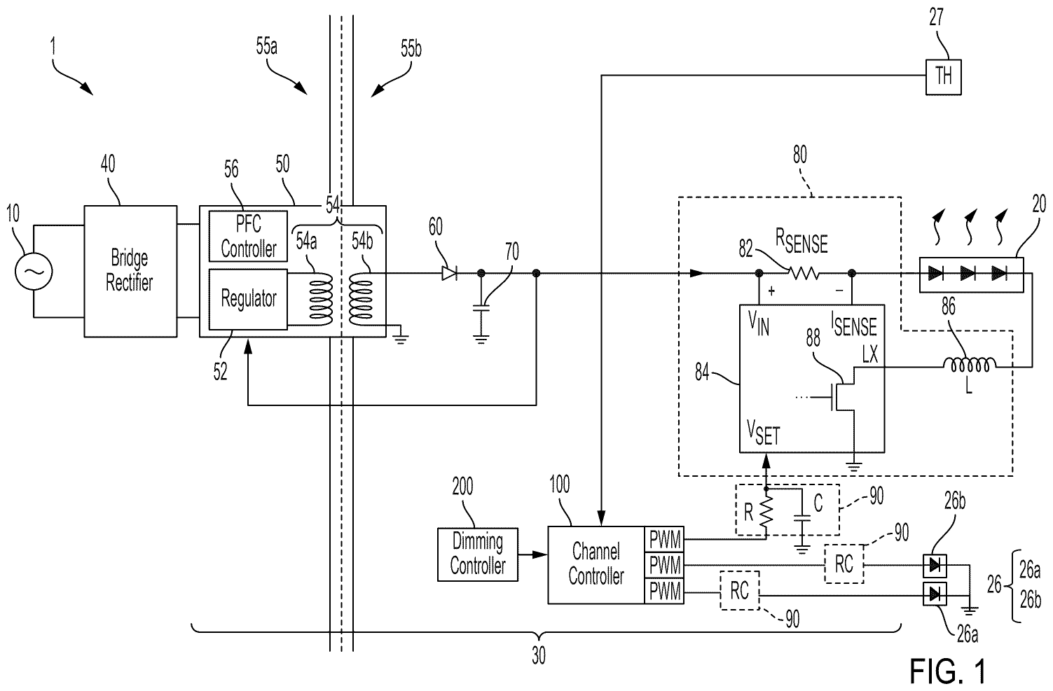

FIG. 1 illustrates a lighting system 1 including a CCT drift compensation mechanism, according to some example embodiments of the present disclosure.

According to some embodiments, the lighting system 1 includes an input source 10, a chip-on-board (COB) light source (henceforth referred to simply as a “COB”) 20 and a light driver 30 for powering and controlling the brightness/intensity of the COB light source 20.

The input source 10 may include an alternating current (AC) power source that may operate at a voltage of 100 Vac, a 120 Vac, a 240 Vac, 277 Vac, or higher, for example. The input source 10 may also include a dimmer electrically powered by said AC power sources. The dimmer may modify (e.g., cut/chop a portion of) the input AC signal according to a dimmer level before sending it to the light driver 30, and thus variably reduces the electrical power delivered to the light driver 30 and the color channels 20, 22, and 24. In some examples, the dimmer may be a TRIAC or ELV dimmer, and may chop the front end or leading edge of the AC input signal. According to some examples, the dimmer interface may be a rocker interface, a tap interface, a slide interface, a rotary interface, or the like.

In some embodiments, the COB 20 may include one or more light-emitting-diodes (LEDs) that are grouped together in clusters and mounted on the same substrate or circuit board.

In some embodiments, the light driver 30 includes an input rectifier (e.g., an input rectifier circuit) 40, a power supply (also referred to as a power supply circuit) 50, an output rectifier 60, a filter 70, a current control circuit 80, and a channel controller 100.

The input rectifier 40 may provide a same polarity of output for either polarity of the AC signal from the input source 10. In some examples, the input rectifier 40 may include a full-wave circuit using a center-tapped transformer, a full-wave bridge circuit with four diodes, a half-wave bridge circuit, or a multi-phase rectifier. The input AC signal may be about 90 VAC to about 305 VAC at 50-60 Hz.

The power supply circuit 50 converts the rectified AC signal generated by the input rectifier 40 into a drive signal for powering the COB 20. In some embodiments, the power supply circuit 50 includes a voltage converter 52 for maintaining (or attempting to maintain) a constant DC bus voltage on its output while drawing a current that is in phase with and at the same frequency as the line voltage (by virtue of a PFC controller/circuit 56). A transformer 54 inside the power supply circuit 50 produces the desired output voltage from the DC bus. In some examples, the power supply circuit 50 may include the PFC circuit (or PFC controller) 56 for improving (e.g., increasing) the power factor of the load on the input source 10 and reducing the total harmonic distortions (THD) of the light driver 30.

In some embodiments, the driving current of the COB 20 may be derived from the secondary winding 54b of the transformer 54.

According to some embodiments, the output rectifier (e.g., diode) 60 and filter (e.g., capacitor) 70 convert the AC driving signal output by the secondary winding 54a of the transformer 54 into a DC drive current for driving the COB 20. The anode of the output rectifier 60 may be connected (e.g., directly connected) to the output terminal of the power supply circuit 50.

According to some embodiments, the current control circuit 80 is configured to adjust the drive current of the COB 20 based on the drive signal from the power supply circuit 50 and a filtered reference signal (e.g., a pulse width modulated (PWM) signal) from the channel controller 100 and the filter circuit 92.

The channel controller 100 may enable light dimming by controlling the color intensity (as measured by lumens, Lm) of the light output by the COB 20. The dimmer level may be determined based on a dimmer setting from a dimming controller 200, which may be in electrical communication with the channel controller 100, as shown in FIG. 1. However, embodiments of the present disclosure are not limited thereto. For example, the dimming controller 200 may also be a TRIAC or ELV dimmer at the input source 10. In some examples, the dimmer level at 100% may correspond to an output light intensity of about 5000 lumens.

In some embodiments, the current control circuit 80 is electrically coupled to the secondary side 55b of the power supply circuit 50. The current control circuit 80 includes a sense resistor (RSENSE) 82 that is coupled in series between the output of the power supply circuit 50 and the COB 20 and is configured to enable sensing of the drive current of the COB 20.

In some embodiments, the current control circuit 80 also includes a regulator (also referred to as a buck regulator, a buck converter, or a step down converter) 84 configured to sense the output voltage of the power supply circuit 50 (e.g., at its VIN input), to sense the drive current via the sense resistor 82 (e.g., at its ISENSE input), to receive the reference signal (e.g., PWM signal) from the channel controller 100 (e.g., at its VSET input), and to regulate the drive current according to the sensed/received signals. The regulator 84 is configured to sense the drive current of the COB 20 by measuring the voltage drop across the sense resistor 82 (via the VIN and the ISENSE inputs). In some embodiments, the drive current passing through the COB 20 is routed back through the regulator 84 (via its LX input) to ground. The regulator 84 includes a switch (e.g., a metal oxide field effect transistor (MOSFET)) capable of switching the drive current on and off based on the sensed output voltage, the sensed drive current, and the reference signal. The current control circuit may also include an inductor 86 coupled between the COB 20 and the regulator 84 and positioned in a current path of the COB 20, which enables the regulator (e.g., the buck regulator) 84 to produce a regulated current. Thus, by controllably switching the drive current on and off, the regulator 84 may provide down-current regulation of the drive current.

To maintain accurate dimming down to 1% while reducing ripple in the drive current, a hybrid DC/PWM signal may be applied to the regulator 84 to achieve the benefits of both DC and PWM dimming. The hybrid DC/PWM signal may be a pseudo-sawtooth waveform that is seen as an effective DC voltage when operating above the regulator's cutoff voltage (which may correspond to about 5% or higher dimming) and is seen as a PWM signal after entering the cutoff region of operation of the regulator 84 (which may correspond to dimming below 5%).

In some examples, to produce the pseudo-sawtooth signal, the channel controller 100 first generates the reference signal in the form of a PWM signal (e.g., a square PWM signal), which oscillates between two discrete values and has an adjustable/variable pulse width or duty cycle. The PWM signal is then filtered by a filter circuit (e.g., a low pass filter) 90 to produce the pseudo-sawtooth signal, which is a smoothly varying analog signal having a triangular or substantially triangular waveform. The low pass filter 90 may be a first order RC filter, as shown in FIG. 1; however, embodiments of the present application are not limited thereto, and the low pass filter 90 may be any suitable filter, such as a higher order filter or an RLC filter.

As will be understood by a person of ordinary skill in the art, embodiments of the present disclosure are not limited to the output stage of the embodiments of FIG. 1. For example, rather than use a regulator at the output stage, some embodiments of the present disclosure may utilize a voltage-controller resistor (VCR) to control the voltage supplied to the light channels.

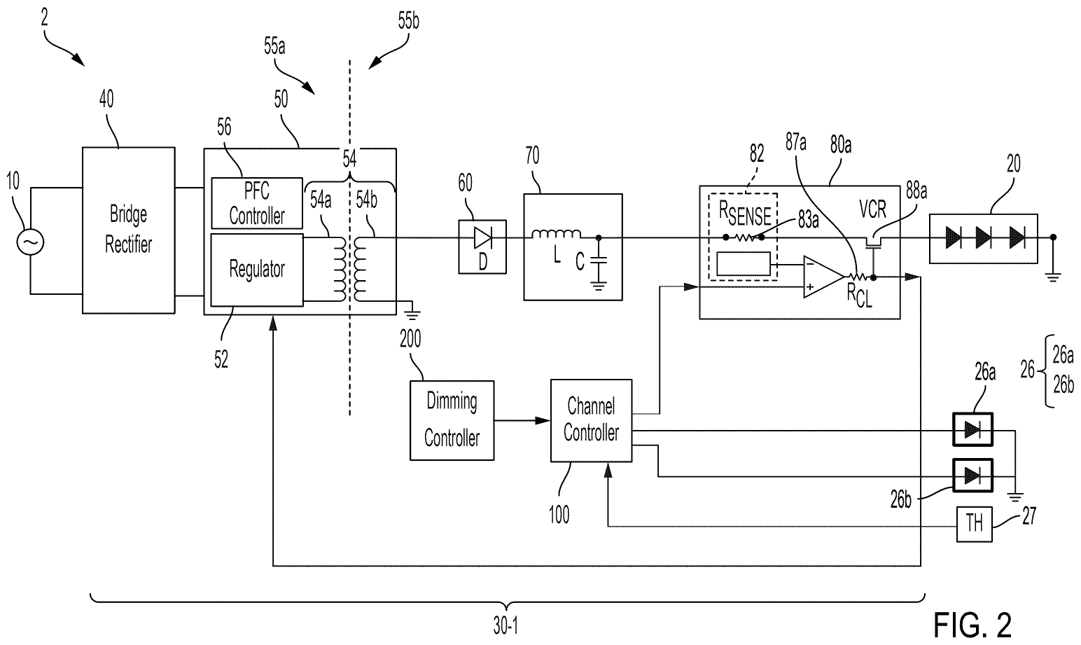

FIG. 2 illustrates a schematic diagram of a lighting system 2 including a current control circuit 80a that utilizes a VCR, according to some embodiments of the present disclosure. The lighting system 2 may be substantially the same as the lighting system 1, except for the current control circuit 80a. As such, a detailed description of the same components as in FIG. 1 may not be repeated here.

Referring to FIG. 2, in some embodiments, the current control circuit 80a includes a current sensor 82a configured to sense the drive current of the COB 20 and to generate a sense signal; an error amplifier (also referred to as a comparator) 86a configured to receive the sense signal from the current sensor 82a and the reference signal (V_{REF}) from the channel controller 100, and to generate a feedback signal (also referred to as an error signal/gate control signal) based on a difference between the reference signal and the sense signal; and a voltage-controlled resistor (VCR, e.g., a linear pass element) 88a that is configured to adjust the corresponding channel current by dynamically adjusting a resistance of the VCR 88a based on the feedback signal from the error amplifier 86a.

The current sensor 82a may include a current sense circuit 84a that is configured to sense the drive current of the COB 20 by measuring the voltage drop across the sense resistor 83a, and to generate the sense signal that is provided to the error amplifier 86a (e.g., to the negative input terminal of the error amplifier 86a).

The VCR 88a may be electrically connected in series with the sense resistor 83a and the COB 20. In some embodiments, the VCR 88a is a field effect transistor (FET), such as a junction FET (JFET) or a metal-oxide-semiconductor FET (MOSFET) that operates in the quasi-saturation region (e.g., linear/ohmic region) and functions as a variable resistor, whose resistance is controlled by the gate voltage.

According to some embodiments, the feedback signal from the error amplifier 86a controls the resistance of the VCR 88a to regulate the channel current to a desired value, which corresponds to the reference signal. As the current control circuits 80a dynamically adjusts the resistance of the VCR 88a in response to the instantaneous changes in the channel current, the current control circuit 80a regulates the channel current to the desired level, as determined by the reference signal. The channel controller 100 may generate the reference signal based on the desired light output intensity of the COB 20, which may be based on the dimmer level.

The power supply circuit 50 may monitor the state of the VCR 88a of the current control circuit 80-1a and may adjust its output voltage (i.e., the output voltage of the secondary winding 54b) to reduce or minimize the voltage drop across the VCRs 88a. In some examples, the feedback signal (also referred to as a correction signal) from the error amplifier 86a that controls the COB 20 is communicated to the power supply circuit. In some embodiments, the feedback signal is provided to the PFC controller circuit 56, which may perform power factor correction for the power supply circuit 50.

### CCT Drift Compensation

Generally, the CCT of light output of a COB is age and temperature sensitive and can change during operation of the lighting system 1/2 as the COB heats up or even over the lifetime of the COB. The shift in CCT may be more prominent and thus more noticeable in application that push COBs close to their maximum limits. In some examples, the COB manufacturer may tune the phosphors in the COB to yield the desired and stable CCT output at a specific temperature range, typically around 85° C. Table 1 shows this variance according to some examples.

TABLE 1

| Temperature (° C.) | CCT |
|---|---|
| 25 | 3135 |
| 85 | 3045 |
| 105 | 2994 |

Thus, if the desired CCT target is about 3045, when the COB temperature is lower than the targeted temperature of 85° C. (e.g., at startup), the CCT of the output light may be too high, and the when the temperature is higher than the targeted temperature (e.g., due to prolonged usage), the CCT of the output light may be too low. What this translates to is that, in practice, when the light is first turned on, it may exhibit the wrong color until it warms up, which may take several noticeable minutes.

As will be understood by a person of ordinary skill in the art, Table 1 illustrates one example, and the CCT variance over temperature may be different for different COBs. For example, depending on the thermal coefficients of the COB, the CCT may be low below the targeted temperature, and may be high above the targeted temperature.

Thus, according to some embodiments, the lighting system 1/2 is capable of providing CCT compensation (e.g., positive and negative CCT compensation) to compensate for this incorrect color production and to produce a substantially uniform CCT output regardless of temperature changes.

Referring to FIGS. 1 and 2, in some embodiments, the lighting system 1/2 further includes an auxiliary light 26, which may include one or more LEDs, that may be mounted in proximity to the chamber in which the COB 20 resides. In some embodiments, the light driver 30 monitors the temperature of the COB 20 over time, which can indicate drift in CCT of the COB light, using a temperature sensor 27. In some examples, the temperature sensor 27 is a thermistor placed adjacent to, or within close proximity to, the COB 20, which communicates the sensed temperature to the channel controller 100. The channel controller 100 in turn drives the auxiliary light 26 with sufficient current (e.g., a compensation drive signal) that causes the auxiliary light 26 to emit a light that when mixed with the COB light can compensate for any CCT drift that the COB 20 may be exhibiting.

In some embodiments, the auxiliary light 26 generates light of a single CCT, which may be higher or lower than the desired CCT of the COB 20 (i.e., the target CCT), and may be able to do one-sided compensation of COB CCT (e.g., positive or negative CCT adjustment). For example, if the auxiliary light 26 has a CCT higher than the target CCT, it may be able to increase the effective CCT of the lighting system 1/2 when the COB CCT drops below the target CCT to have it reach the target CCT. Similarly, if the auxiliary light 26 has a CCT lower than the target CCT, it may be able to lower the effective CCT of the lighting system 1/2 when the COB CCT increases above the target CCT to have it reach the target CCT. However, embodiments of the present disclosure are not limited to one-sided CCT compensation.

According to some embodiments, the auxiliary light 26 generates light of a two different CCTs, one of which is higher than the target CCT and the other of which is lower than the target CCT, and may be able to do dual-sided compensation of COB CCT (e.g., positive and negative CCT adjustment) to regulate the output CCT of the lighting system 1/2 to the target CCT.

In some embodiments, the auxiliary light 26 includes: a first auxiliary light 26a configured to emit a first compensation light of a CCT higher than that of the light source (e.g., higher than that of the target CCT) in response to a first compensation drive signal, and a second auxiliary light 26b configured to emit a second compensation light of a CCT lower than that of the light source (e.g., lower than that of the target CCT) in response to a second compensation drive signal. The first and second compensation drive signals collectively form the compensation drive signal generated by the channel controller 100. Depending on the light source temperature and CCT thermal coefficients of the light source, the channel controller 100 may drive one or both of the first and second auxiliary lights to produce the desired target CCT.

Depending on the intensity of the compensation light and dimming levels, the power output of the auxiliary light 26 may be one or two orders of magnitude lower than the COB. As such, the addition of the compensation light to the lighting system 1/2 may not meaningfully affect the overall power consumption. As an example, the CCT of a 3000 K high-power (i.e., high output lumen) COB may shift to about 3300 K over time. Here, the light of a low-powered 2000 K auxiliary light 26 (e.g., a 2000 K LED) may be mixed with that of the COB to compensate for the 300 K CCT drift and to produce a 3000 K light at about the same output power.

Here, the CCT compensation effect of the auxiliary light 26 may be adjusted by controlling the current delivered to it.

In some embodiment, the light driver 30/30-1 has stored therein (e.g., in a memory local to the channel controller 100) a first look-up table (LUT; also referred to as a temperature compensation table) that translates/maps the COB temperature (also referred to as a light source temperature) to a compensation current for driving the auxiliary light 26, which can offset the CCT drift exhibited by the COB 20 at that temperature. The light driver 30/30-1 utilizes the first LUT to drive the compensation line based on the sensed temperature. If a particular sensed temperature falls between two mapped temperatures of the LUT, the light driver 30 may employ interpolation to determine (e.g., estimate) the corresponding compensation current amount. However, embodiments of the present disclosure are not limited thereto, and the function of the first LUT may be replaced with an equation/formula that associates COB temperatures with compensation drive signals for driving the auxiliary light 26 to offset the CCT drift in the COB output light at the corresponding COB temperatures.

In embodiments in which the auxiliary light 26 can provide dual-side CCT compensation via first and second auxiliary lights 26a and 26b, the first LUT (or its equivalent equation/formula) associates (e.g., translates/maps) the COB temperature with compensation drive signals for driving the first and second auxiliary lights 26a and 26b to offset the CCT drift in the COB output light at the corresponding COB temperatures.

The mapped temperatures and compensation currents of the LUT may be experimentally derived. As such, the compensation effect of the light driver 30 may not be very sensitive to the particular location of the temperature sensor 27 and its proximity to the COB 20. This is because, even if there is a temperature offset between the COB 20 and the sensing location (i.e., physical location of the temperature sensor 27), that offset is expected to be relatively constant during operation, and thus can be manually calibrated when establishing the LUT. In such instances, the mapped temperatures correspond to the temperatures at the sense location. Therefore, in application where the channel controller 100 is relatively near the COB 20 (e.g., when on the same PCB), rather than rely on a thermistor 27, the light driver 30 may utilize the internal temperature sensor of the channel controller 100 to approximate the COB temperature.

In addition to the temperature of the COB 20, the CCT of the light output of the COB 20 may be affected by its effective age. For example, the COB CCT may gradually decrease over time. Thus, according to some embodiments, in generating the compensation drive signal, the channel controller 100 considers not only the real-time temperature of the COB 20 but also the effective age of the COB 20.

In some embodiments, the channel controller 100 determines the age of the COB 20 based on a cumulative operating time of the COB 20 and temperatures and light output intensities of the COB 20 over the cumulative operating time of the light source, which may be recoded and stored in memory of the channel controller 100.

In some embodiment, the light driver 30/30-1 has stored therein (e.g., in a memory local to the channel controller 100) a second look-up table (LUT; also referred to as an age compensation table) that maps/translates the effective age of the COB 20 to one or more compensation drive signals for driving the auxiliary light 26 (e.g., 26a and 26b) to offset the CCT drift in the output light of the COB 20 resulting from the age of the COB 20.

In embodiments in which age is also considered, the channel controller 100 may combine (e.g., multiply or convolve) the compensation signals derived from the first and second lookup tables to arrive at the compensation drive signal(s) sent to the auxiliary light 26 (e.g., 26a and 26b).

When the compensation drive signal is a PWM signal, the compensation signals recorded in the first and second LUTs may be PWM duty cycles encoded as integers, for example, on a scale of 0 to 10,000, where 10,000 may represent 100% duty cycle. The compensation signals recorded in the first and second LUTs may also be direct PWM register values. PWM register values may be the amount of timer cycles used by the PWM's clock timer, up to a pre-defined maximum where the maximum would correspond to 100% duty at the specified PWM frequency. For a 3.11 kHz PWM, that may correspond to values from 0 to 3215 (which are outside of IEEE visible flicker measurement range of below 3.1 kHz).

According to some other embodiments, the channel control may utilize an age compensation table, which maps the effective age of COB 20 (as described above) to an age-based CCT, and a temperature compensation table, which maps the real-time COB temperature to a scalar value for scaling the age-based CCT values from the age compensation table, to determine the compensation drive signal. The values stored in the age compensation table may be based on data that is experimentally derived, or industry standard or manufacturer standard formulas, or the like. Similarly, the temperature compensation table may be based on experimentally-derived data. In some examples, the age compensation table and the temperature compensation table may be replaced with corresponding equations.

The channel controller 100 may multiply the output from the age compensation table (i.e., the age-based CCT) by the output of the temperature compensation table (i.e., scalar value) to determine an estimated CCT of the COB 20, after accounting for both age and real time temperature.

The channel controller 100 may then utilize a third lookup table that maps the estimated CCT of the COB 20 to one or more compensation drive signals for transmission to one or more of the first and second auxiliary lights 26a and 26b for achieving the desired target CCT.

In still other embodiments, the channel controller 100 generates the compensation drive signal based on a multi-dimensional look-up table (LUT) mapping the real-time COB temperature as measured by the sensor 27, a cumulative operating time of the light source, and an average temperature and an average light output intensity of the light source over the cumulative operating time of the light source to the compensation drive signal.

In some embodiments, the compensation light produced by the auxiliary light 26 is injected through a reflector to be mixed with the light produced by the COB light via the reflector.

In some embodiments, the drive signal generated by the channel controller 100 may be a PWM signal. In some examples, a filter circuit (e.g., a low pass or RC filter) 90 filters the PWM signal to produce a DC or sawtooth drive signal that can be used to drive the auxiliary light 26 (see, e.g., FIG. 1). However, embodiments of the present disclosure are not limited thereto. For example, when the frequency of the PWM signal is sufficiently high, the PWM signal may be supplied directly to the auxiliary light 26 (see, e.g., FIG. 2).

This is due to the fact that at sufficiently high frequencies, there may be no visible flicker present in the mixed light output by the lighting system 1/2. In other examples, the compensation drive signal may be a DC signal that can be supplied directly to the auxiliary light 26 without any filtering.

According to some embodiments, the components of the light driver 1/2 are packaged within a multi-layered lighting system 1/2 that has a multi-level printed circuit board (PCB) design that vertically stacks two or more PCB layers coupled by connectors/separators. The components of the lighting system 1/2 are mounted on the top side of the bottom PCB (e.g., main PCB) or on both the top and bottom sides of the remaining PCB board layers (e.g., daughter board layers). These layers may be added or removed in order to provide more space to mount all the components for the lighting system 1/2.

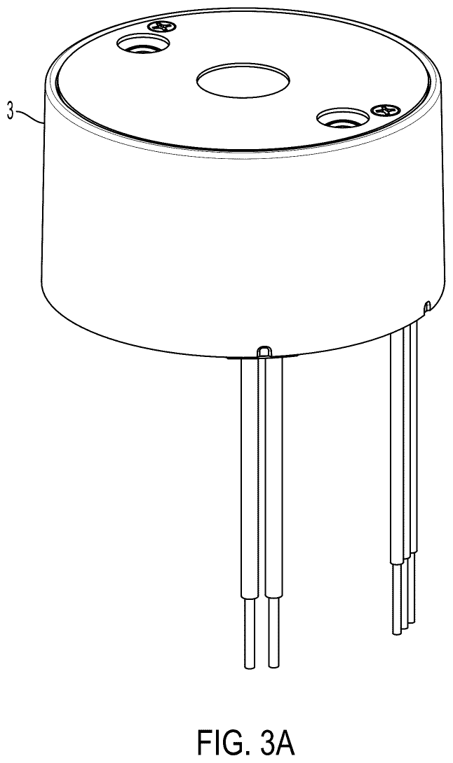

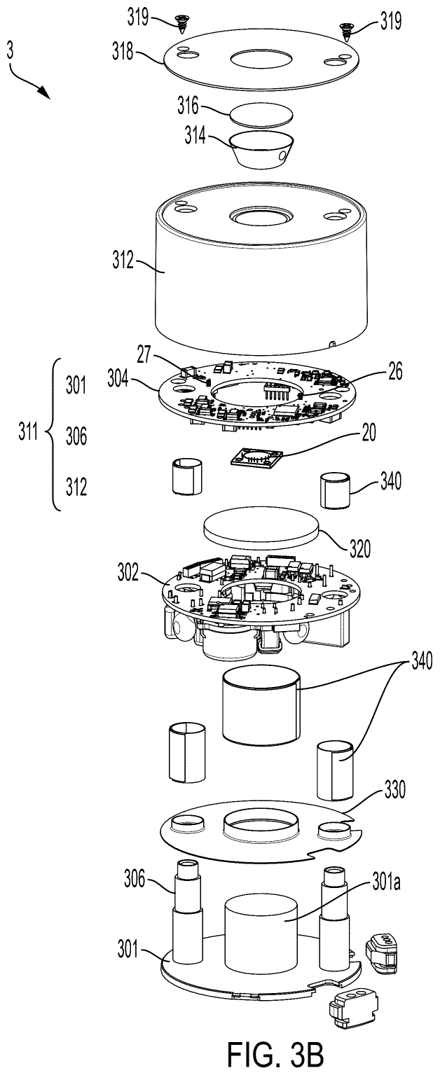

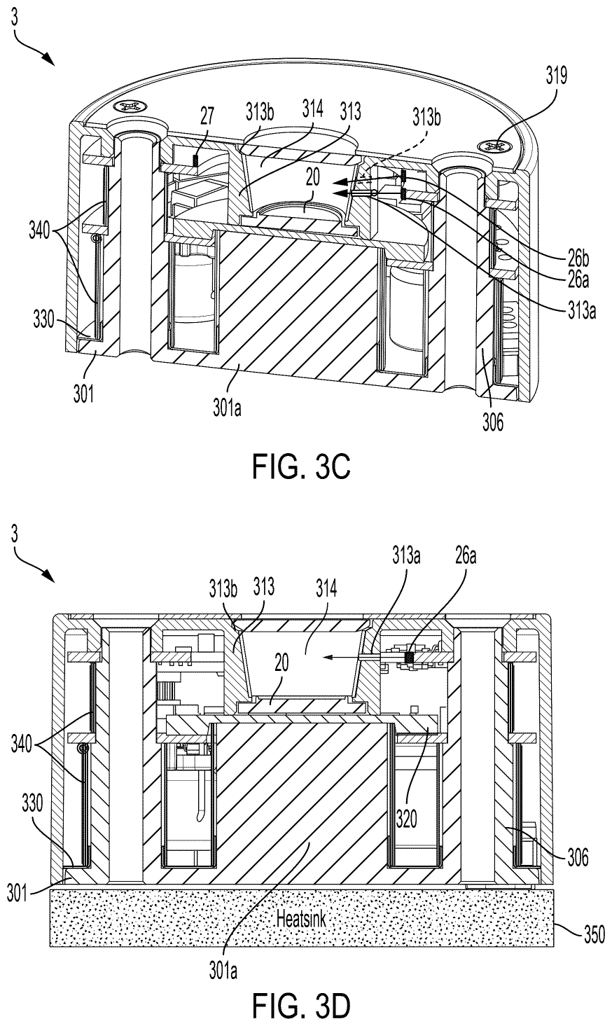

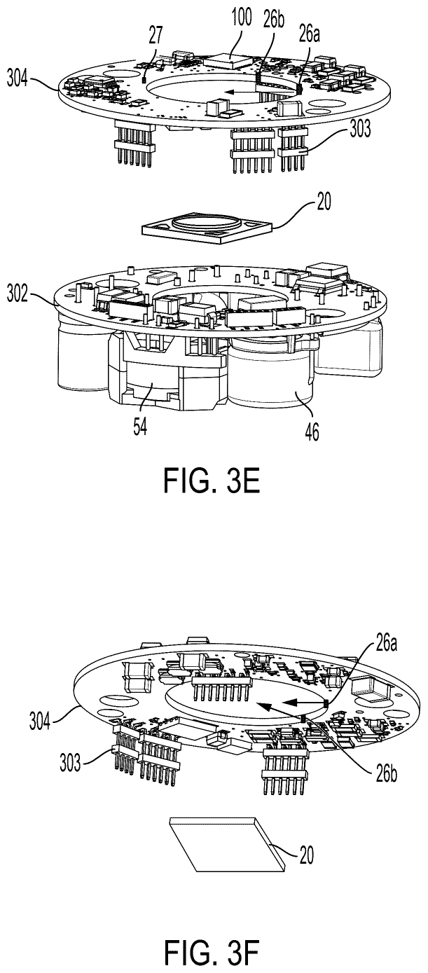

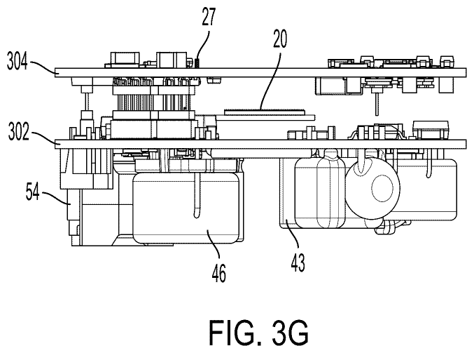

FIG. 3A illustrates a perspective view of a lighting system 3, according to some embodiments of the present disclosure. FIG. 3B illustrates an exploded perspective view of the lighting system 3, according to some embodiments of the present disclosure. FIG. 3C illustrates a cutaway perspective view of the lighting system 3, according to some embodiments of the present disclosure. FIG. 3D illustrates a cross-sectional view of the lighting system 3, according to some embodiments of the present disclosure. FIGS. 3E and 3F illustrate an exploded perspective view of the layers of the lighting system 3 on which the internal electrical components are mounted to, according to some embodiments of the present disclosure. FIG. 3G illustrates a partial side view of the layers of the lighting system 3, according to some embodiments of the present disclosure. The internal circuitry of the lighting system 3 may be that of any of the lighting systems 1 or 2 that were discussed above with respect to FIGS. 1-2.

According to some embodiments, the compact lighting system 3 includes the power supply, which converts AC to DC, and the light source (e.g., a COB light) in one compact package having an aperture (e.g., a round aperture). The lighting system 3 is fully configurable and can be programmed (on the production line or in operation) to produce any light output color, and any light intensity (e.g., 3 k or 4 k lumen). COBs, and hence the lighting system 3 of the present disclosure, can be used for aesthetics purposes in architectural designs, or can be used for illumination in general lighting applications.

The input to the lighting system 3 is an AC signal that may be provided by a neutral line and one power line from the wall (i.e., no ground line). The lighting system 3 may receive AC input from about 90 VAC to about 305 VAC (which is considered to be a high voltage). The system 3 performs the voltage conversion (AC-DC), and produces the desired light output. This is in contrast to the related art in which the light engines input DC voltages and relay on external power supplies that convert wall AC into a DC voltage. By incorporating the AC-DC voltage converting power supply into the same package as the light driver, the system 3 eliminates the need for an additional power supply, which saves cost and simplifies installation.

In some examples, the lighting system 3 is a static white AC-input LED engine having a high lumen output. In some examples, the lighting system 3 may be a cylindrical light fixture having a diameter of about 50 mm. The flat top may have an aperture (e.g., a round lens) with an LES of about 9 mm or 12 mm. The light system 3 may be able to produce a light output of about 1500 lm. In some examples, the lighting system 3 may utilize a single CCT COB to achieve narrower LES and higher lumen output. It may provide high lumens per watt (LPW) but with no white tuning. However, these are merely examples, and the lighting system 3 may have any suitable dimension, aperture size, and any suitable lumen output.

Referring to FIG. 3B, the lighting system 3 has a 2-layer structure including a first layer 302 and a second layer 304 coupled to and vertically offset from the first layer 302 by two or more base posts 306. The layers 302 and 304 may include PCBs having one or more layers (e.g., metal layers).

In some embodiments, the housing 311 of the lighting system 3 includes a heatsink base 301 at the bottom side/backside of the lighting system 3, which faces away from the layers 302 and 304, and has a central pedestal (or pillar) structure 301a that protrudes from the heatsink base 301 toward the top surface of the lighting system 3. The heatsink base 301 and the pedestal (or pillar) structure 301a together form a heatsink for the light source 20 and components of the lighting system 3.

The base posts 306 may extend vertically from the heatsink base 301 to the top of the case cover 312 within the interior space of the housing 311. The base posts 306 may not only couple the case cover 312 to the heatsink base 301, but they also support the first and second layers 302 and 304 above the heatsink base 301 via one or more stepped portions at the exterior of the base posts 306. In some examples, the base posts 306 may have a hollow interior allowing a fastener to pass therethrough and couple the lighting system 3 to a heatsink mount (e.g., a fixture heatsink), which may be a passive heat exchanger or an active heat exchanger (e.g., including a fan).

In some embodiments, the first and second layers 302 and 304 may be ring-shaped and have openings in theirs centers that allow the pedestal 301a to pass therethrough. The first and second layers 302 and 304 may be vertically offset from the heatsink base 301, thus allowing components to be mounted one both sides of each of the first and second layers 302 and 304.

In some embodiments, the integrated multi-layered lighting system 3 includes a light source 20 positioned above, supported by, and is thermally connected to the heatsink pedestal 301a. The opening of the second layer 304 allows for the light produced by the light source 20, which may include a COB light, to pass through the second layer 304 without obstruction and to illuminate the target environment.

The housing 311 also includes a case cover 312 that, together with the heatsink base 301, encompass/encase the components within the lighting system 3 and protects them from the elements. At its center, the case cover 312 may have an inner/inward extension portion 313 defining an opening (or a case/housing opening) that can act as a light tunnel directing light produced by the light source 20 to the outside. A reflector (e.g., metal reflector) 314 may be placed inside the case/housing opening to ensure that the light produced by the light source 20 is not absorbed by the interior walls of the case/housing opening, and thus improve (e.g., increase) the light extraction efficiency of the lighting system 3. The reflector 314 may rest on or contact the inner surface of the inner extension portion 313. The reflector 314 may have a cylindrical shape (as shown in FIGS. 3B-3D) or may be inwardly tapered. A glass lens 316 may fit within a notched portion 313b of the case/housing opening and be held in place above the light source 20 by a hold-down cap (e.g., a ring-shaped hold-down cap) 318 that is fastened (e.g., screwed) to the top of the case cover 312.

To improve the dissipation of heat generated by the light source 20, the light source 20 is placed on top of the heatsink pedestal 301a, which is thermally and electrically conductive and channels/transfers the light source-generated heat to the heatsink base 301 and the outside (e.g., via the heatsink mount/fixture 850). In some examples, a thermal conductivity pad 320 may fill the gap between the light source 20 and the top surface of the conductive (and grounded) pedestal 301a. In addition to acting as a heatsink, the pedestal 301a positions the light source 20 closer to the round aperture 316, which allows the lighting system 3 to improve light extraction efficiency and to achieve a target 100 lumens/watt out of the small aperture.

In some embodiments, one of more components of at least one of the power supply 50 and one or more components of the light driver 30 are mounted on at least an underside of the first layer 302 facing the heatsink base 301. Further, one of more components of at least one of the power supply 50 or the light driver 30 are mounted on a top side of the first layer 302 facing away from the heatsink base 301. Similarly, one of more components of at least one of the power supply 50 or the light driver 30 are mounted on an underside of the second layer 304 facing the first layer 302, one of more components of at least one of the power supply 50 or the light driver 30 are mounted on a top side of the second layer 304 facing away from the first layer 302.

As shown, in some examples, the second components mounted on the first and second layers 302 and 304 may be electrically connected to one another through one or more electrical connectors/links 303.

In some examples, the lighting system 3 utilizes a COB (e.g., a single CCT COB) 20, which is supported by the pedestal 301a. A thermal gap pad 320 may also fill the gap between the pedestal 301a and the COB 20. One or more of the first and second layers 302 and 304 may have wired connections to the COB 20.

In some embodiments, the case cover 312 of the housing 311 may have an inner/inward extension portion 313 that is inwardly tapered and serves to center and secure COB 20. The reflector 314 may conform to the shape of the inner/inward extension portion 313 and may be held in place by the lens (e.g., a glass lens) 316, which may fit within the peripheral notch (or stepped portion) 313b of the case cover 312. The lens 316 may be held in place above the COB 20 by a cap (e.g., a ring-shaped hold-down cap) 318 that is configured to be fixedly attached to (e.g., fastened or screwed to) the top of the case cover 312, for example, via one or more screws 319.

According to some embodiments, the auxiliary light 26 is positioned to emit light toward the light mixing chamber, which is the interior space defined by the reflector 314, the lens 316, and the COB 20. As shown in FIGS. 3C-3D, the light mixing chamber may have the shape of a reverse cone frustum. In some embodiments, the auxiliary light 26 is located at the inner region (e.g., at or near the inner opening) of the second layer 304 and facing inward toward the center of the housing 311. The light from the auxiliary light 26 may reach the mixing chamber by virtue of a hole 313a that extends (e.g., horizontally) through the inner extension portion 313 and the reflector 314. The hole 313a may be small enough to allow light from the auxiliary light 26 to enter the mixing chamber, but prevent any meaningful amount of light from exiting the chamber therethrough. Once the light emitted from the auxiliary light 26 enters through the hole 313a, it reflects off the surfaces of the reflector 314 and mixes with the light emitted by the COB 20.

As described above with respect to FIGS. 1-2, in some embodiments, the auxiliary light 26 includes first and second auxiliary lights 26a and 26b having different CCT light output. In some examples, the first and second auxiliary lights 26a and 26b may be packaged together as a multi-CCT single-chip LED light and thus the same hole 313a may be used to mix the first and/or second compensation light with the COB light in the mixing chamber. In other examples, the first and second auxiliary lights 26a and 26b may be separately packaged as discrete components. In such examples (see, e.g., FIGS. 3C, 3E, and 3F), the first and second auxiliary lights 26a and 26b may be positioned at different locations around the mixing chamber and may inject the first and second compensation lights through a first hole 313a and a second 313b that extend (e.g., horizontally) through the inner extension portion 313 and at an angle with respect to the interior reflection surface of the reflector 314.

By not placing the auxiliary light 26 next to the COB 20 and moving it to the outer side of the reflector 314, the above-described design may increase (e.g., maximize) the ratio of lumen output per light emitting surface area. As such, this may improve space utilization and improve (e.g., increase) light output density of the lighting system 3.

According to some embodiments, the temperature sensor 27, which is configured to measure or approximate the temperature of the COB 20, is placed near or on the COB 20. In designs such as that of FIGS. 3C and 3D in which the COB 20 cannot be directly accessed, the temperature sensor 27 may be placed outside of the inner extension portion 313. For example, the temperature sensor 27 may be attached to the outer surface of the inner extension portion 313 or may be positioned at the inner region of the second layer 304. While the temperature at the location of the temperature sensor 27 may be different from that at the COB 20 itself, the temperature delta/difference may be about constant during normal operations. As such, this difference, which can be experimentally determined, may be accounted for and calibrated when constructing the LUT table that maps the sensed temperature to compensation current that drives the auxiliary light 26. Thus, in some examples, depending on the thermal path between the channel controller 100 and the COB 20, the temperature sensor may be that which is internal to the channel controller 100.

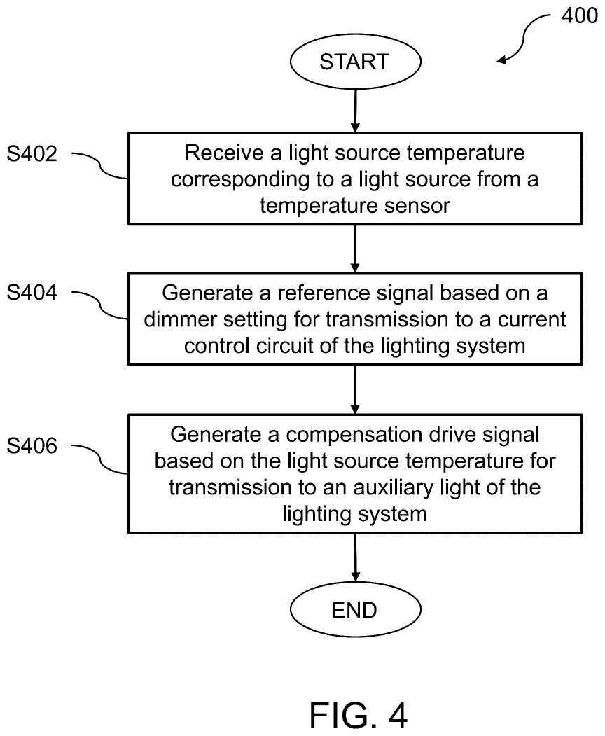

FIG. 4 is a flow diagram illustrating a process 400 of compensating a CCT drift in an output light of a light source 20 of a lighting system 1/2/3, according to some embodiments of the present disclosure.

Referring to FIG. 4, the channel controller 100 of the lighting system 1/2 receives a light source temperature corresponding to the light source 20 from a temperature sensor 27 (S402).

In some embodiments, the channel controller 100 generates a reference signal based on a dimmer setting for transmission to a current control circuit 80/80a of the lighting system 1/2 (S404). The current control circuit 80/80a is coupled to the light source 20 and is configured to adjust a current of the light source 20 based on a drive signal and the reference signal.

In some embodiments, the channel controller 100 generates a compensation drive signal based on the light source temperature for transmission to an auxiliary light 26 of the lighting system 1/2 (S406). The auxiliary light 26 is configured to generate compensation light for compensating the CCT drift in the output light of the light source 20 based on the compensation drive signal.

Accordingly, as described above, by monitoring the temperature of the COB light, the light driver is able to mix sufficient amount of light from the auxiliary light 26 to produce a light output that is compensated for the CCT drift of the COB light. This enables the lighting system to produce a light with consistent CCT during its period of operation.

### Lumen Drift Compensation

LEDs, while widely used for their energy efficiency and versatility, face performance challenges due to lumen drift, which is the gradual decrease in light output over time. This issue is primarily caused by temperature variations, as the heat generated during LED operation raises the junction temperature, leading to reduced light conversion efficiency and diminished lumen output. Although improvements in heat dissipation and thermal management have been made, there remains a need for more effective solutions to address lumen drift and ensure consistent LED performance across varying temperatures.

Aspects of embodiments of the present disclosure aim to tackle this problem by providing a novel method to minimize lumen drift and enhance the stability of LED-based lighting systems. According to some embodiments, the lighting system monitors the temperature of the light source, utilizes one or more look-up table (LUT) to determine the lumen drift based on at least the light source temperature, and adjusts the driving current of the light source accordingly to compensate for the drift and to produce a consistent light output intensity.

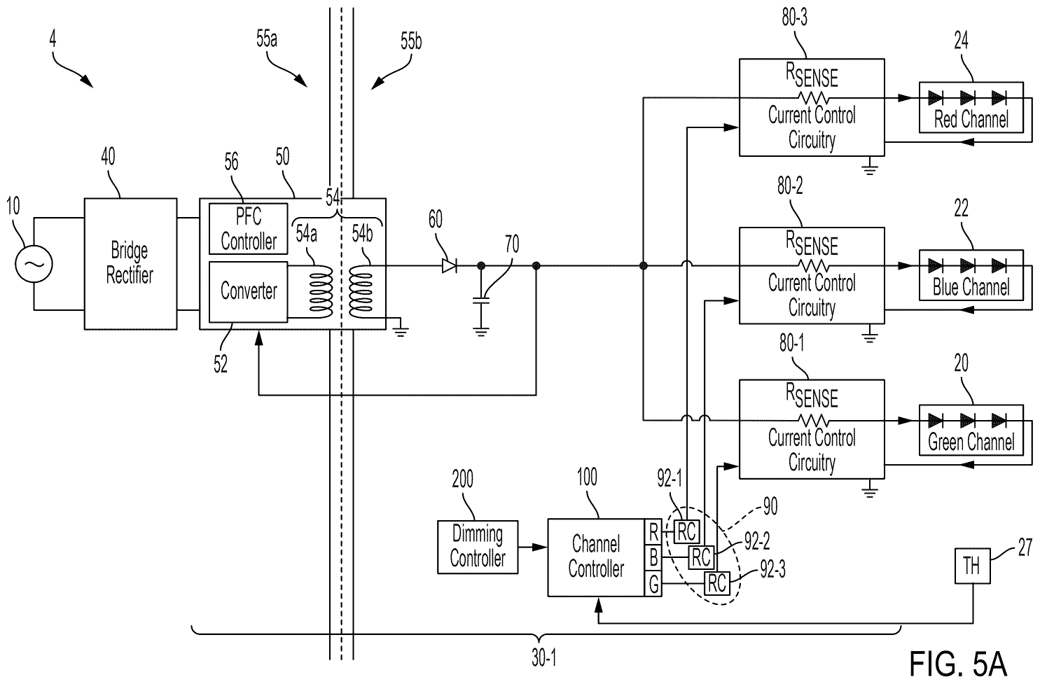

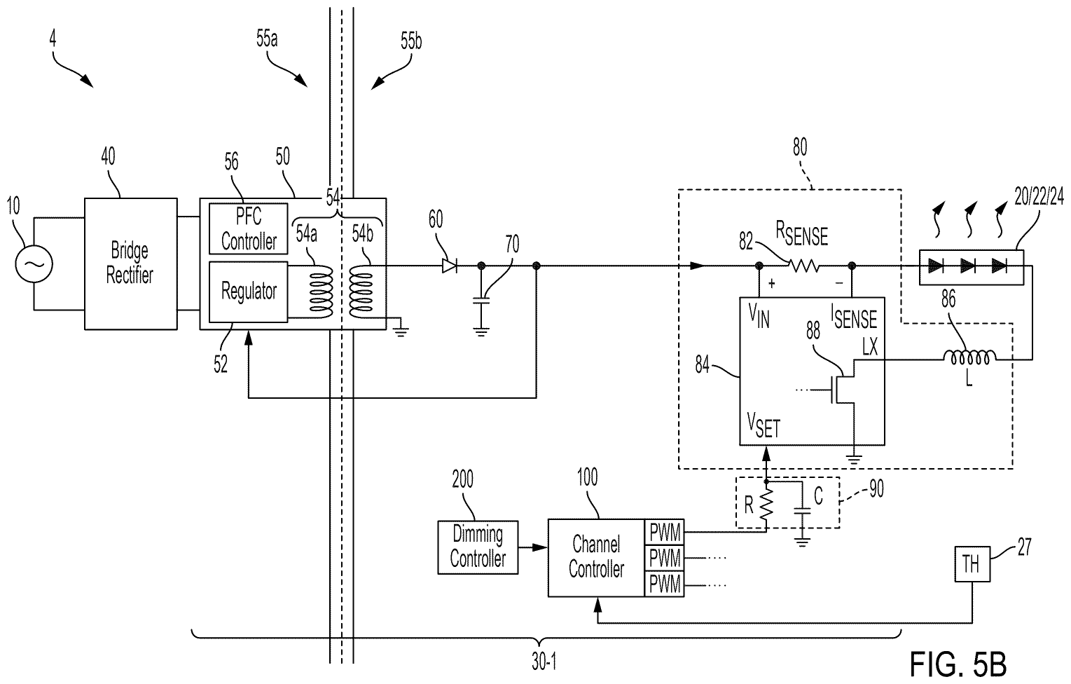

FIG. 5A illustrates a lighting system 4 including a multi-channel light driver 30-1 and a lumen drift compensation mechanism, according to some example embodiments of the present disclosure. FIG. 5B illustrates a schematic diagram of a current control circuit 80 of the multi-channel light driver 30-1, according to some embodiments of the present disclosure.

The lighting system 4 may be substantially similar to the lighting system 1 of FIG. 1, except for the use of a plurality of color channels. A such overlapping descriptions may not be repeated for sake of brevity.

Referring to FIGS. 5A-5B, according to some embodiments, the lighting system 4 includes a plurality of colored light sources (e.g., a plurality of LED channels) 20, 22, and 24, and a multi-channel light driver 30-1 for powering and controlling the brightness/intensity of the colored light sources 20, 22, and 24.

In some embodiments, the plurality of color channels includes a first colored light source (e.g., a green LED channel) 20, a second colored light source (e.g., a blue LED channel) 22, and a third colored light source (e.g., a red LED channel) 24. Each channel may include one or more light-emitting-diodes (LEDs) of the corresponding colors (e.g., red, green, or blue LEDs). While in some embodiments, the first through third color channels 22-24 represent RGB colors, embodiments of the present disclosure are not limited thereto, and the plurality of channels may include any suitable number of color channels. Further, embodiments, of the present disclosure are not limited to LEDs, and in some examples, other solid-state lighting devices may be employed.

According to some embodiments, the multi-channel light driver 30-1 drives the plurality of colored light sources 20, 22, and 24 to produce light temperatures that follow the blackbody curve. In so doing, the multi-channel light driver 30-1 may perform color mixing of, for example, red, blue, and green light to achieve the desired light temperature. In some embodiments, the multi-channel light driver 30-1 determines the color temperature based on a dimmer setting, a time of day, or a combination thereof.

In some embodiments, the driving current of each of the plurality of colored light sources 20, 22, and 24 may be derived from the same secondary winding 54b of the transformer 54. While the plurality of colored light sources 20, 22, and 24 are driven by the same winding, the channel current of each color channel is independent of the other color channels. This independent control of the channel currents is enabled by utilizing a separate/different current control circuit 80 for each colored light source 20/22/24.

According to some embodiments, the colored light sources 20, 22, and 24 share a common output rectifier (e.g., diode) 60 and filter (e.g., capacitor) 70, which convert the AC driving signal output by the secondary winding 54a of the transformer 54 into a DC channel current for driving the colored light sources 20, 22, and 24. The anode of the output rectifier 60 may be connected (e.g., directly connected) to the output terminal of the power supply circuit 50.

According to some embodiments, each of the plurality of current control circuits 80-1 to 80-3 is configured to adjust the channel current of the corresponding colored light source 20/22/24 based on the drive signal from the power supply circuit 50 and a corresponding filtered reference signal (e.g., a pulse width modulated (PWM) signal) from the channel controller 100 and the filter circuit 90. By controlling the color intensity (as measured by lumens, Lm) of each of the red, blue, and green colors output by the colored light sources 20, 22, and 24, the channel controller 100 may not only enable light dimming, but also adjusts the color mixing of the channels 20, 22, and 24 to replicate light temperatures (temperature in kelvins, K), which follow the black body curve. The channel controller 100 determines the color mix (e.g., the intensity of the red, blue, and green light colors) for each color temperature based on a lookup table that provides the light intensities of the different color channels. The tabulated color mix may accurately follow the black body curve.

In some embodiments, the current control circuit 80 is electrically coupled to the secondary side 55b of the power supply circuit 50. The current control circuit 80 includes a sense resistor (R_{SENSE}) 82 that is coupled between the output of the power supply circuit 50 and the corresponding colored light source 20/22/24 and is connected electrically in series with the corresponding colored light source 20/22/24. The sense resistor 82 is configured to enable sensing of the channel current (I_{CHANNEL}) of the corresponding colored light source 20/22/24.

Referring to FIG. 5B, in some embodiments, the current control circuit 80 also includes the regulator 84 that receives the reference signal (e.g., PWM signal) corresponding to the colored light source 20/22/24 from the channel controller 100 regulates the channel current accordingly. While FIG. 5B illustrates only a single color channel for ease of illustration, the lighting system 4 includes a separate current control circuit 80 for each of the colored light sources 20, 22, and 24.

The channel controller 100 may enable light dimming by controlling the color intensity (as measured by lumens, Lm) of the light output by the plurality of colored light sources 20, 22, and 24.

As will be understood by a person of ordinary skill in the art, embodiments of the present disclosure are not limited to the output stages of the embodiments of FIGS. 5A-5B. For example, rather than use a regulator at the output stage, some embodiments of the present disclosure may utilize a voltage-controller resistor (VCR) to control the voltage supplied to the light channels.

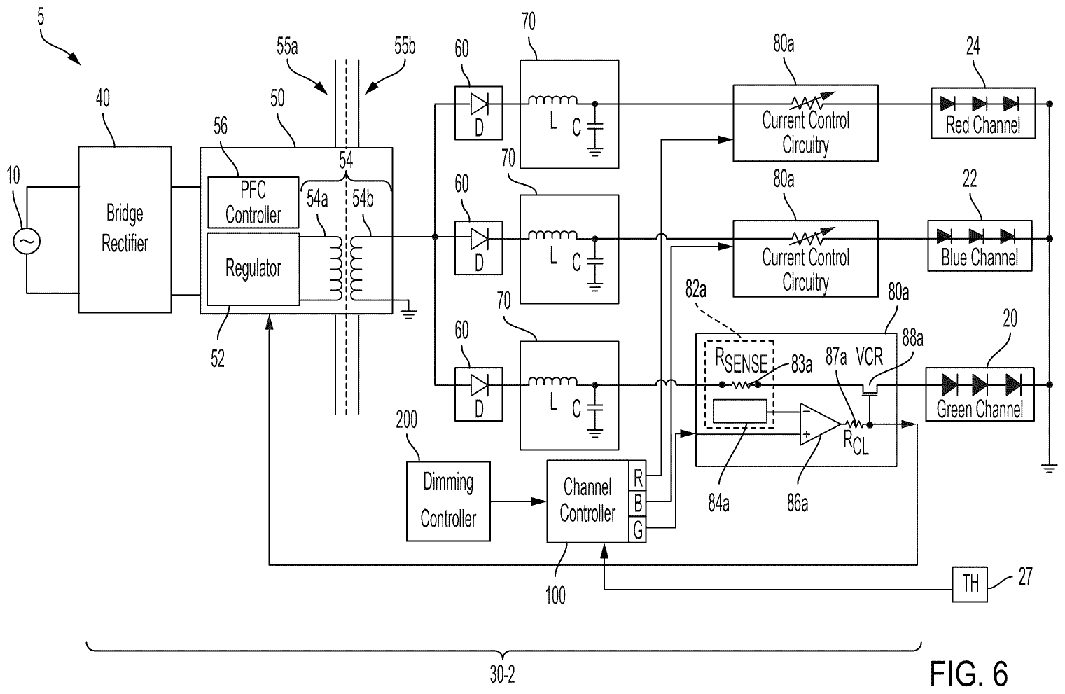

FIG. 6 illustrates a schematic diagram of a current control circuit 80a utilizing a VCR, according to some embodiments of the present disclosure. As shown in FIG. 6, the lumen compensation mechanism of the light driver 30-2 is the same as that described above with respect to FIGS. 5A-5B and operates in the same manner. As such, a detailed description thereof may not be repeated here.

According to some embodiments, the channel controller 100 generates a reference signal for each of the plurality of colored light source 20, 22, and 24 based on the desired color intensity of the channels. For example, when the color channels include a green color channel 20, a blue color channel 22, and a red color channel 24, the channel controller may generate a first reference signal corresponding to the desired green color intensity to send to the first current control circuit 80a associated with the green color channel 20; may generate a second reference signal corresponding to the desired blue color intensity to send to the second current control circuit 80a associated with the blue color channel 22; and may generate a third reference signal corresponding to the desired red color intensity to send to the third current control circuit 80a associated with the red color channel 24.

In some examples, the feedback signal (also referred to as a correction signal) from the error amplifier 86a that controls the green color channel 20 is communicated to the power supply circuit.

In some embodiments, when the error amplifier 86a of the current control circuit 80-1a determines to increase the drive current of the green color channel 20 (e.g., when increasing the intensity of the green light), the corresponding feedback signal, which is transmitted to the primary side 55a, notifies the power supply circuit 50 to increase its output voltage to ensure sufficient drive voltage for the green color channel 20 (and hence the blue and red color channels 22 and 24). Conversely, when the error amplifier 86a of the current control circuit 80-1a determines to decrease the drive current of the green color channel 20 (e.g., when reducing the intensity of the green light), the corresponding feedback signal notifies the power supply circuit 50 to decrease its output voltage to prevent excessive power dissipation by the VCRs 88a.

As such, by properly controlling the voltage headroom, the power supply circuit 50 may provide sufficient drive voltage and current to drive all of the independent color channels, while reducing or minimizing excess power dissipation by the VCRs. The multi-channel light driver 30-2 controls the headroom of all channels by using only a single feedback/control loop from one dominant color channel (e.g., the green color channel), rather than several different feedback loops. This greatly simplifies the control logic of the light driver 30-2, which translates to lower overall cost and size of the system.

During normal operation, the colored light sources 20, 22, 24 generate heat and gradually experience an increase in temperature. This increase in temperature can result in a loss in lumens output, which if not corrected could lead to an undesired dimming of the light sources 20, 22, 24. The lumen output may also be affected by the effective age of the LED, since LEDs tend to produce less lumen for a given drive current as they age. This shift in output lumens may be more prominent and thus more noticeable in application that push LEDs close to their maximum limits.

Thus, according to some embodiments, the lighting system 4 is capable of providing lumen compensation to compensate for the drop in lumens and to produce a substantially uniform lumen output regardless of temperature changes.

In some embodiments, the light driver 30 monitors the temperature of the colored light sources 20, 22, 24 over time, which can indicate drift in lumen of the light sources 20, 22, 24, using a temperature sensor 27. In some examples, the temperature sensor 27 is a thermistor placed adjacent to, or within close proximity to, the colored light sources 20, 22, 24 (or close to at least one of them). Once the temperature sensor 27 performs a measurement, it communicates the sensed temperature to the channel controller 100. Based on the sensed temperature, the channel controller 100 determines the amount by which to increment or reduce the reference signal for each colored light sources 20, 22, 24 to compensate for any lumen drift.

In some embodiment, the light driver has stored therein (e.g., in a memory local to the channel controller 100) a fourth look-up table (LUT; also referred to as a lumens compensation table) that translates/maps the light source temperature to a reference signal delta for adding to the calculated reference signals for each color channel. When added to the corresponding reference signals that drive each channel, the delta can offset the lumen drift exhibited by the colored light sources 20, 22, 24 at that temperature. If a particular sensed temperature falls between two mapped temperatures of the LUT, the channel controller 100 may employ interpolation to determine (e.g., estimate) the corresponding reference signal delta. However, embodiments of the present disclosure are not limited thereto, and the function of the fourth LUT may be replaced with an equation/formula that associates light source temperatures with reference signal deltas for adjusting the reference signal to offset the lumen drift in the output light at the corresponding light source temperatures. In some examples, the reference signals of each of the channels may be augmented with the same delta.

The mapped temperatures and compensation currents of the LUT may be experimentally derived. As such, the compensation effect of the light driver 30 may not be very sensitive to the particular location of the temperature sensor 27 and its proximity to the light sources 20, 22, 24. This is because, even if there is a temperature offset between the light sources 20, 22, 24 and the sensing location (i.e., the physical location of the temperature sensor 27), that offset is expected to be relatively constant during operation, and thus can be manually calibrated when establishing the LUT. In such instances, the mapped temperatures correspond to the temperatures at the sense location. Therefore, in applications where the channel controller 100 is relatively near the light sources 20, 22, 24 (e.g., when on the same PCB), rather than rely on a thermistor 27, the light driver 30 may utilize the internal temperature sensor of the channel controller 100 to approximate the light temperature.

In addition to the temperature of the light source 20/22/24, the lumen of the light output of the light source 20/22/24 may be affected by its effective age. For example, the lumen output may gradually decrease over time. Thus, according to some embodiments, in generating the adjusted reference signal, the channel controller 100 considers not only the real-time temperature of the light source 20/22/24 but also the effective age of the light source 20/22/24.

In some embodiments, the channel controller 100 determines the age of the light source 20/22/24 based on a cumulative operating time of the light source 20/22/24 and temperatures and light output intensities of the light source 20/22/24 over the cumulative operating time of the light source, which may be recoded and stored in memory of the channel controller 100. Thus, in some examples, the channel controller 100 may track the individual ages of the first to third light sources 10, 22, and 24. However, embodiments of the present disclosure are not limited thereto, and the channel control may track a single age, such as the age of the green light source 20 as a representative of the other light sources, or an average age of the light sources 20, 22, and 24.

In some embodiment, the light driver 30/30-1 has stored therein (e.g., in a memory local to the channel controller 100) a second look-up table (LUT; also referred to as an age compensation table) that maps/translates the effective age of the light source 20/22/24 to a reference signal delta for addition to the reference signal to offset the lumen drift in the output light of the light source 20/22/24 resulting from the age of the light source 20/22/24.

In embodiments in which age is also considered, the channel controller 100 may combine (e.g., multiply or convolve) the reference signal delta derived from the first and second lookup tables to arrive at the reference signal delta for addition to the corresponding reference signal.

According to some other embodiments, the channel control may utilize an age compensation table, which maps the effective age of light sources 20/22/24 (as described above) to an age-based lumen output, and a temperature compensation table, which maps the real-time light source temperature to a scalar value for scaling the age-based lumen values from the age compensation table, to determine the reference signal delta. The values stored in the age compensation table may be based on data that is experimentally derived, or industry standard or manufacturer standard formulas, or the like. Similarly, the temperature compensation table may be based on experimentally-derived data. In some examples, the age compensation table and the temperature compensation table may be replaced with corresponding equations.

The channel controller 100 may multiply the output from the age compensation table (i.e., the age-based lumen output) by the output of the temperature compensation table (i.e., the scalar value) to determine an estimated lumen of the light source 20, after accounting for both age and real time temperature.

The channel controller 100 may then utilize a third lookup table that maps the estimated lumen of the light source 20 to a reference signal delta for addition to the reference signal in order to achieve the desired target lumen output.

In still other embodiments, the channel controller 100 generates the adjusted reference signal based on a multi-dimensional look-up table (LUT) mapping the real-time COB temperature as measured by the sensor 27, a cumulative operating time of the light source, and an average temperature and an average light output intensity of the light source over the cumulative operating time of the light source to the reference signal delta for addition to the reference signal.

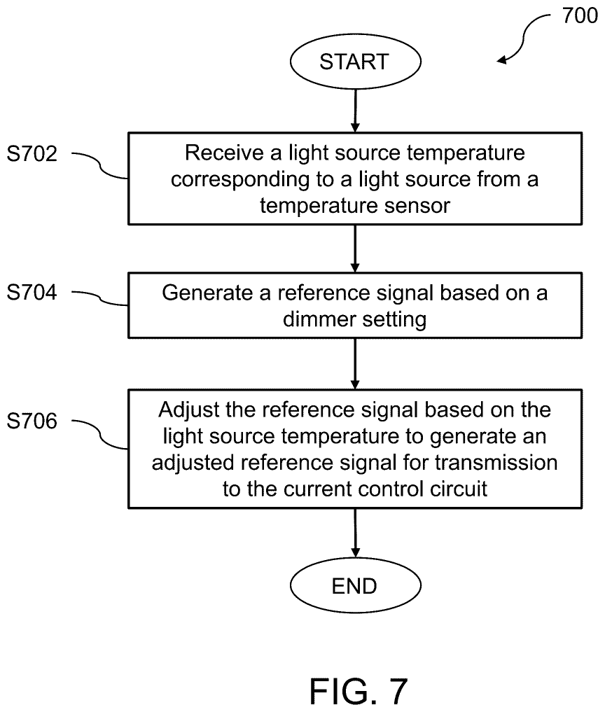

FIG. 7 is a flow diagram illustrating a process 700 of compensating a lumen drift in an output light of a light source 20/22/24 of a lighting system 4/5, according to some embodiments of the present disclosure.

Referring to FIG. 7, the channel controller 100 of the lighting system 4/5 receives a light source temperature corresponding to the light source 20/22/24 from a temperature sensor 27 (S702).

In some embodiments, the channel controller 100 generates a reference signal based on a dimmer setting (S704).

In some embodiments, the channel controller 100 adjusts the reference signal based on the light source temperature to generate an adjusted reference signal for transmission to a current control circuit 80/80a of the lighting system 4/5 (S706). The current control circuit 80/80a is coupled to the light source 20/22/24 and is configured to adjust a current of the light source 20/22/24 based on a drive signal and the adjusted reference signal.

Accordingly, as described above, by monitoring the temperature of the light sources, the light driver is able to compensate the drive signals to compensate for any temperature-dependent lumen drift and to produce a light output with consistent intensity during its period of operation.

It will be understood that, although the terms “first”, “second”, “third”, etc., may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of”, when preceding a list of elements, modify the entire list of elements and do not modify the individual elements of the list. Further, the use of “may” when describing embodiments of the inventive concept refers to “one or more embodiments of the inventive concept”. Also, the term “exemplary” is intended to refer to an example or illustration.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the terms “substantially”, “about”, and similar terms are used as terms of approximation and not as terms of degree, and are intended to account for the inherent variations in measured or calculated values that would be recognized by those of ordinary skill in the art.

As used herein, the terms “use”, “using”, and “used” may be considered synonymous with the terms “utilize”, “utilizing”, and “utilized”, respectively.

The integrated multi-layered lighting system and/or any other relevant devices or components, such as the channel controller, according to some embodiments of the present invention described herein may be implemented by utilizing any suitable hardware, firmware (e.g., an application-specific integrated circuit), software, or a suitable combination of software, firmware, and hardware. For example, the various components of the independent multi-source display device may be formed on one integrated circuit (IC) chip or on separate IC chips. Further, the various components of the LED driver may be implemented on a flexible printed circuit film, a tape carrier package (TCP), a printed circuit board (PCB), or formed on the same substrate. Further, the various components of the LED driver may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer-readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

While this invention has been described in detail with particular references to illustrative embodiments thereof, the embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims and equivalents thereof.

What is claimed is:

1. A lighting system comprising:
a power supply circuit configured to generate a drive signal for powering a light source based on an input power signal;
a temperature sensor configured to measure a light source temperature corresponding to the light source;
a current control circuit coupled to the light source and configured to adjust a current of the light source based on the drive signal and an adjusted reference signal; and
a channel controller configured generate a reference signal based on a dimmer setting, and to adjust the reference signal based on the light source temperature to generate the adjusted reference signal.

2. The lighting system of claim 1, wherein the temperature sensor is a thermistor within a housing of the light source and adjacent to the light source.

3. The lighting system of claim 1, wherein the channel controller is configured to receive the dimmer setting from a dimming controller.

4. The lighting system of claim 1, wherein the channel controller is configured to adjust the reference signal based on a first look-up table (LUT) associating light source temperatures with reference signal deltas for addition to the reference signal to offset a lumen drift in an output light of the light source at corresponding light source temperatures.

5. The lighting system of claim 1, wherein the channel controller is configured to adjust the reference signal based on an equation associating light source temperatures with reference signal deltas for addition to the reference signal to offset a lumen drift in an output light of the light source at corresponding light source temperatures.

6. The lighting system of claim 1, wherein the channel controller is further configured to determine an age of the light source based on a cumulative operating time of the light source and temperatures and light output intensities of the light source over the cumulative operating time of the light source, and to generate the adjusted reference signal further based on the age of the light source.

7. The lighting system of claim 1, wherein the channel controller is configured to generate the adjusted reference signal further based on a second look-up table (LUT) associating ages of the light source with reference signal deltas for addition to the reference signal to offset a lumen drift in an output light of the light source at corresponding ages of the light source, and
wherein each of the ages of the light source based on a cumulative operating time of the light source and temperatures and light output intensities of the light source over the cumulative operating time of the light source.

8. The lighting system of claim 1, wherein the channel controller is configured to generate the adjusted reference signal based on a multi-dimensional look-up table (LUT) mapping the light source temperature, a cumulative operating time of the light source, and an average temperature and an average light output intensity of the light source over the cumulative operating time of the light source to a reference signal delta for addition to the reference signal.

9. The lighting system of claim 1, wherein the channel controller is configured to:
determine an age of the light source;
determine an age-based lumen value corresponding to the light source based on the age and an age compensation table that maps the age to the age-based lumen value;
determine a scalar value based on the light source temperature and a temperature compensation table that maps the light source temperature to the scalar value for scaling the age-based lumen value;
determine an estimated lumen value of the light source by multiplying the age-based lumen value by the scalar value;
determine a reference signal delta based on the estimated lumen value and a third lookup table that maps the estimated lumen value of the light source to the reference signal delta for addition to the reference signal; and
calculating the adjusted reference signal based on the reference signal and the reference signal delta.

10. The lighting system of claim 1, wherein the power supply circuit comprises:
a voltage regulator; and
a transformer having a primary winding coupled to the voltage regulator and a secondary winding electrically isolated from the primary winding and coupled to the current control circuit.

11. The lighting system of claim 1, further comprising:
a rectifier circuit configured to rectify the input power signal to generate a rectified signal having a single polarity,
wherein the power supply circuit is configured to generate the drive signal based on the rectified signal, and
wherein the rectifier circuit is a bridge rectifier and the input power signal is an alternating-current (AC) signal.

12. The lighting system of claim 1, wherein the light source is one of a plurality of light sources comprising a first light source, a second light source, and a third light source,
wherein the first light source comprises one or more green light emitting diodes (LEDs),
wherein the second light source comprises one or more blue LEDs, and
wherein the third light source comprises one or more red LEDs.

13. A method of compensating a lumen drift in an output light of a light source of a lighting system, the method comprising:
receiving, by a channel controller of the lighting system, a light source temperature corresponding to the light source from a temperature sensor;
generating, by the channel controller, a reference signal based on a dimmer setting; and
adjusting, by the channel controller, the reference signal based on the light source temperature to generate an adjusted reference signal for transmission to a current control circuit of the lighting system, the current control circuit being coupled to the light source and configured to adjust a current of the light source based on a drive signal and the adjusted reference signal.

14. The method of claim 13, further comprising:
receiving, by the channel controller, the dimmer setting from a dimming controller.

15. The method of claim 13, wherein the light system further comprises:
a power supply circuit configured to generate the drive signal for powering the light source based on an input power signal.

16. The method of claim 13, wherein the adjusting the reference signal is based on a first look-up table (LUT) associating light source temperatures with reference signal deltas for addition to the reference signal to offset the lumen drift in the output light of the light source at corresponding light source temperatures.

17. The method of claim 13, wherein the adjusting the reference signal is further based on a second look-up table (LUT) associating ages of the light source with reference signal deltas for addition to the reference signal to offset the lumen drift in the output light of the light source, and
wherein each of the ages of the light source based on a cumulative operating time of the light source and temperatures and light output intensities of the light source over the cumulative operating time of the light source.

18. The method of claim 13, further comprising:
determining, by the channel controller, an age of the light source based on a cumulative operating time of the light source and temperatures and light output intensities of the light source over the cumulative operating time of the light source,
wherein the adjusting the reference signal is further based on is further based on the age of the light source.

19. The method of claim 13, wherein the adjusting the reference signal comprises:
determining an age of the light source;
determining an age-based lumen value corresponding to the light source based on the age and an age compensation table that maps the age to the age-based lumen value;
determining a scalar value based on the light source temperature and a temperature compensation table that maps the light source temperature to the scalar value for scaling the age-based lumen value;
determining an estimated lumen value of the light source by multiplying the age-based lumen value by the scalar value;
determining a reference signal delta based on the estimated lumen value and a third lookup table that maps the estimated lumen value of the light source to the reference signal delta for addition to the reference signal; and
calculating the adjusted reference signal based on the reference signal and the reference signal delta.
